(19) United States
(12) Patent Application Publication
(10) Pub. No.: US 2025/0192485 A1
(43) Pub. Date: Jun. 12, 2025

(54) Power source converter having data telescoping line

(71) Applicant: Dongguan Best Travel Electronics Co., Ltd., Dongguan (CN)

(72) Inventors: Guangli Zeng, Dongguan (CN); Chengbing Wang, Dongguan (CN); Feng Wang, Dongguan (CN)

(21) Appl. No.: 18/792,937

(22) Filed: Aug. 2, 2024

(30) Foreign Application Priority Data
Dec. 7, 2023 (CN) 202323338381.8
Jan. 12, 2024 (CN) 202410052998.3

(51) Int. Cl. H01R 13/72; H01R 13/66

(52) U.S. Cl. CPC H01R 13/72; H01R 13/6675

(57) ABSTRACT

A power source converter body and a PCB provided in the power source converter body, The present disclosure provides a power source converter having a data telescoping line, wherein the data line is accommodated in the power source converter, so as to save space and avoid the trouble of providing an extra plug for power source conversion of the data telescoping line; moreover, it is adaptable for the conduction and connection of different pin assemblies in the power source converter, and can provide stable connection, as a result of which the power source converter is more practical.

### CROSS REFERENCE TO RELATED APPLICATION

This application claims priority benefit of Chinese patent Application No. 202323338381.8, filed on Dec. 7, 2023, No. 202410052998.3, filed on Jan. 12, 2024, and the entire contents of which are incorporated herein by reference.

### TECHNICAL FIELD

The present disclosure relates to the technical field of power source converter, in particular to a power source converter having a data telescoping line.

### BACKGROUND

Plugs and sockets in different countries are different in specifications, and thus are not universal. Therefore, a power source converter is necessary when a plug needs to be inserted into a socket of unmatched specification. Power source converters are a type of switching tool. In use, a power source converter will be inserted into a target socket; and then conversion can be realized as long as a target plug is inserted into matching socket apertures in the power source converter. Power source converters make people's life outside more convenient, especially for international travels when there is no worry about whether the plug of a portable electronic device can match a local power socket.

To make the converters more universal, some power source converters are provided with pins of multiple specifications; in use, necessary pins can be easily pushed out and inserted into a target socket. Usually, these pins are regular ones, such as British-standard pins, American-standard pins and so on. All existing converters on the market need extra charging lines for charging portable electronic devices. However, consumers always forget to carry the charging lines, which causes troubles for overseas business trips.

### SUMMARY

To overcome the afore-mentioned shortcomings, the present disclosure provides a power source converter having a data telescoping line, wherein the data line is accommodated in the power source converter, so as to save space and avoid the trouble of providing an extra plug for power source conversion of the data telescoping line; moreover, it is adaptable for the conduction and connection of different pin assemblies in the power source converter, and can provide stable connection, as a result of which the power source converter is more practical.

In order to realize the above-mentioned object, the present disclosure adopts a technical solution as below.

A power source converter having a data telescoping line, comprising a power source converter body and a PCB provided in the power source converter body, and further comprising a European-standard pin assembly provided in the power source converter body and a data-line rotating and connecting device; wherein: the data-line rotating and connecting device comprises a first terminal assembly, and a second terminal assembly rotatably provided on the first terminal assembly; the first terminal assembly comprises a first terminal fixing plate, and plural conductive terminals embedded in the first terminal fixing plate; the second terminal assembly comprises: a second terminal fixing plate that covers and fits the first terminal fixing plate, a data line rotatably provided between the first terminal fixing plate and the second terminal fixing plate, and a wiring board that is in electric connection to the data line and is positioned between the data line and the first terminal fixing plate; the wiring board is provided with plural conductive solder pads that match, abut against and conduct with the conductive terminals; and at least one conducting part is provided on the conductive terminals, and the conducting part abuts against the conductive solder pads.

As a further improvement of the present disclosure, the data-line rotating and connecting device is provided between the PCB and the European-standard pin assembly, and is in electric connection to the PCB.

As a further improvement of the present disclosure, both the conductive terminals and the conductive solder pads are in 5 sets; the conductive terminals are respectively: a first conductive terminal embedded in the first terminal fixing plate, a second conductive terminal embedded in the first terminal fixing plate, a third conductive terminal embedded in the first terminal fixing plate, a fourth conductive terminal embedded in the first terminal fixing plate, and a fifth conductive terminal embedded in the first terminal fixing plate; and the conductive solder pads are respectively: a first conductive solder pad, a second conductive solder pad, a third conductive solder pad, a fourth conductive solder pad, and a fifth conductive solder pad.

As a further improvement of the present disclosure, the first conductive terminal comprises: a first circuit board connecting end extending to one side outside the first terminal fixing plate away from the wiring board, a first conducting piece connected to the first circuit board connecting end and matching the first conductive solder pad, and at least one first conducting part formed on the first conducting piece and bent to abut against the first conductive solder pad; the second conductive terminal comprises: a second circuit board connecting end extending to one side outside the first terminal fixing plate away from the wiring board, a second conducting piece connected to the second circuit board connecting end and matching the second conductive solder pad, and at least one second conducting part formed on the second conducting piece and bent to abut against the second conductive solder pad; the third conductive terminal comprises: a third circuit board connecting end extending to one side outside the first terminal fixing plate away from the wiring board, a third conducting piece connected to the third circuit board connecting end and matching the third conductive solder pad, and at least one third conducting part formed on the third conducting piece and bent to abut against the third conductive solder pad; the fourth conductive terminal comprises: a fourth circuit board connecting end extending to one side outside the first terminal fixing plate away from the wiring board, a fourth conducting piece connected to the fourth circuit board connecting end and matching the fourth conductive solder pad, and at least one fourth conducting part formed on the fourth conducting piece and bent to abut against the fourth conductive solder pad; the fifth conductive terminal comprises: a fifth circuit board connecting end extending to one side outside the first terminal fixing plate away from the wiring board, a fifth conducting piece connected to the fifth circuit board connecting end and matching the fifth conductive solder pad, and at least one fifth conducting part formed on the fifth conducting piece and bent to abut against the fifth conductive solder pad.

As a further improvement of the present disclosure, a middle part of the first terminal fixing plate is provided with a mounting slot for wiring and conduction, into which the wiring board can be embedded, wherein the mounting slot for wiring and conduction is provided with: at least one first conducting slot, through which the first conducting part stretches to abut against the first conductive solder pad, at least one second conducting slot, through which the second conducting part stretches to abut against the second conductive solder pad, at least one third conducting slot, through which the third conducting part stretches to abut against the third conductive solder pad, at least one fourth conducting slot, through which the fourth conducting part stretches to abut against the fourth conductive solder pad, and at least one fifth conducting slot, through which the fifth conducting part stretches to abut against the fifth conductive solder pad; and four corners of the first terminal fixing plate are respectively provided with an integral mounting column extending towards the second terminal fixing plate.

As a further improvement of the present disclosure, a live line conducting assembly, which is provided on the PCB and is in electric connection to the PCB, and a zero line conducting assembly, which is provided on the PCB and is in electric connection to the PCB, are comprised.

As a further improvement of the present disclosure, the live line conducting assembly comprises: a first live line conducting piece, a PCB live line gripper formed at one end of the first live line conducting piece and gripping the PCB, a second live line conducting piece, a first live line gripper formed at one end of the second live line conducting piece close to the first live line conducting piece and gripping the other end of the first live line conducting piece, and a European-standard live line gripper provided at one side of the second live line conducting piece close to the European-standard pin assembly.

As a further improvement of the present disclosure, the zero line conducting assembly comprises: a first zero line conducting piece, a PCB zero line gripper formed at one end of the first zero line conducting piece and gripping the PCB, a second zero line conducting piece, a first zero line gripper formed at one end of the second zero line conducting piece close to the first zero line conducting piece and gripping the other end of the first zero line conducting piece, and a European-standard zero line gripper provided at one side of the second zero line conducting piece close to the European-standard pin assembly.

As a further improvement of the present disclosure, the European-standard pin assembly comprises: a European-standard button provided in the power source converter body, a European-standard live line pin provided on the European-standard button, a European-standard live line conducting piece provided between the European-standard live line pin and the European-standard button and facing the European-standard live line gripper, a European-standard zero line pin provided on the European-standard button, and a European-standard zero line conducting piece provided between the European-standard zero line pin and the European-standard button and facing the European-standard zero line gripper.

As a further improvement of the present disclosure, the power source converter body further comprises a housing, and an outermost end of the data line is provided with an interface, wherein: the interface is sleeved with a fixing and accommodating part, and the housing is provided with a line accommodating groove matching the data line, and a fixing and accommodating groove formed in the line accommodating groove and matching the fixing and accommodating part.

As a further improvement of the present disclosure, the fixing and accommodating part comprises a fixing part sleeving the data line and having a hollow and flat shape as a whole, an all-in-one clamping part formed at one side of the fixing part, and an all-in-one limiting part formed at the other side of the fixing part; the clamping part comprises a first clamping structure, which has one side connected to a side edge of the fixing part and takes a U-shaped structure as a whole, a second clamping structure formed at a middle part of an outer side of the first clamping structure and protruding outwards, and a third clamping structure formed at an outer side of the first clamping structure and respectively located at two ends of the second clamping structure; the fixing and accommodating groove comprises a fixing-part accommodating groove formed at a middle part of the line accommodating groove, and a fixing and accommodating groove formed at one side of the fixing-part accommodating groove and matching the clamping part; a clamping block inclining and extending from outside top towards inside bottom is formed at one side of the fixing and clamping groove away from the fixing-part accommodating groove; and the third clamping structure is clamped under the clamping block, and the second clamping structure covers and fits the clamping block.

The beneficial effects of the present disclosure are as follows.

The power source converter is provided to comprise a power source converter body and a PCB provided in the power source converter body, and further comprises a European-standard pin assembly provided in the power source converter body, and a data-line rotating and connecting device, which is provided between the PCB and the European-standard pin assembly and is in electric connection to PCB; the data-line rotating and connecting device is provided in the power source converter body and is in electric connection to PCB; and a joint described hereinafter protrudes out of the power source converter body, as a result, people can pull the data line out of the data-line rotating and connecting device so as to directly charge a phone, a tablet or the like, which avoids the trouble of arranging an extra plug that connects to the data line for power source conversion, and saves space. The data-line rotating and connecting device is transversely provided between the PCB and the European-standard pin assembly, so that the space of the data-line rotating and connecting device in the power source converter is rationalized, and the problem of affecting the operation of other pins in the power source converter can be avoided, thereby making the power source converter small and portable.

The data-line rotating and connecting device is provided to comprise a first terminal assembly and a second terminal assembly rotatably provided on the first terminal assembly; the first terminal assembly comprises a first terminal fixing plate, and plural conductive terminals embedded in the first terminal fixing plate; the second terminal assembly comprises a second terminal fixing plate that covers and fits the first terminal fixing plate, a data line rotatably provided between the first terminal fixing plate and the second terminal fixing plate, and a wiring board that is in electric connection to the data line and is positioned between the data line and the first terminal fixing plate; the wiring board is provided with plural conductive solder pads that match, abut against and conduct with the conductive terminals; and at least one conducting part is provided on the conductive terminals, and the connecting part abuts against the conductive solder pads. When the data line is needed and is pulled by people, it can rotate with the first terminal fixing plate or the second terminal fixing plate as an axis and drive the wiring board to rotate together; while being rotated, the conductive terminals stably abut against corresponding conductive solder pads on the wiring board, and thus realizes stable conduction between the data line connected to the wiring board and conductive terminals, fixed conduction between conductive terminals and PCB, and the conduction between PCB and an external power source, thereby realizing stable conduction between the data line and the external power source. After molding, the conductive terminals are placed into the mold of the first terminal fixing plate, which is molded by means of direct injection, as a result, conductive terminals are stably embedded in the first terminal fixing plate and will not be displaced, thereby avoiding the normal conduction failure caused by displacement of conductive terminals driven by the second terminal assembly. The present power source converter has a simple and clear overall structure, low production cost, and stable conduction during rotation, and thus is highly practical.

Afore-mentioned is an overview of the technical solution of the present disclosure. With reference to the drawing and embodiments, the present disclosure will be further explained.

### DESCRIPTION OF DRAWINGS

FIG. 1 is an overall diagram of Example I;

FIG. 2 is an overall diagram showing the other side of Example I;

FIG. 3 is a diagram of the interior structure of Example I without the housing;

FIG. 4 is an overall diagram of the data-line rotating and connecting device;

FIG. 5 is an exploded view of the data-line rotating and connecting device;

FIG. 6 is an exploded view of the other side of the data-line rotating and connecting device;

FIG. 7 is a structure diagram of conductive terminals;

FIG. 8 is a diagram of conductive terminals abutting against the wiring board;

FIG. 9 is a diagram of the first telescoping assembly;

FIG. 10 is a bottom structure view of Example I without the housing;

FIG. 11 is a structure diagram of a live line conducting assembly and a zero line conducting assembly;

FIG. 12 is an exploded view of a European-standard pin assembly, a live line conducting assembly and a zero line conducting assembly;

FIG. 13 is a diagram of conduction of a European-standard pin assembly respectively to a live line conducting assembly and a zero line conducting assembly;

FIG. 14 is an exploded view of a British-standard pin assembly, a live line conducting assembly and a zero line conducting assembly;

FIG. 15 is a diagram of conduction of a British-standard pin assembly respectively to a live line conducting assembly and a zero line conducting assembly;

FIG. 16 is an exploded view of a Chinese-standard or Australian-standard pin assembly, a live line conducting assembly and a zero line conducting assembly;

FIG. 17 is an exploded view of a Chinese-standard or Australian-standard pin assembly, a live line conducting assembly and a zero line conducting assembly;

FIG. 18 is an overview of Example I when the data line is accommodated in the housing;

FIG. 19 is a structure diagram of the joint and the fixing and accommodating part of the data line;

FIG. 20 is a diagram of one side of the housing;

FIG. 21 is a cross-section diagram of the housing;

FIG. 22 is an exploded view of Example II; and

FIG. 23 is an exploded view of the other side of Example II.

In the drawings:
010: Power source converter body;
020: PCB;
030: European-standard pin assembly; 031: European-standard button; 032: European-standard live line pin; 033: European-standard live line conducting piece; 034: European-standard zero line pin; 035: European-standard zero line conducting piece;
040: Data-line rotating and connecting device; 041: First terminal assembly; 0411: First terminal fixing plate; 04111: Mounting slot for wiring and conduction; 04112: First conducting slot; 04113: Second conducting slot; 04114: Third conducting slot; 04115: Fourth conducting slot; 04116: Fifth conducting slot; 04117: Integral mounting column; 04118: Second axis; 041181: Second spring mounting groove; 0412: First conductive terminal; 04121: First wiring board connecting end; 04122: First conducting piece; 04123: First conducting part; 0413: Second conductive terminal; 04131: Second circuit board connecting end; 04132: Second conducting piece; 04133: Second conducting part; 0414: Third conductive terminal; 04141: Third circuit board connecting end; 04142: Third conducting piece; 04143: Third conducting part; 0415: Fourth conductive terminal; 04151: Fourth circuit board connecting end; 04152: Fourth conducting piece; 04153: Fourth conducting part; 0416: Fifth conductive terminal; 04161: Fifth circuit board connecting end; 04162: Fifth conducting piece; 04163: Fifth conducting part; 042: Second terminal assembly; 0421: Second terminal fixing plate; 04211: Mounting and fixing hole; 04212: First axis; 042121: First spring mounting groove; 0422: Data line; 04221: Interface; 0423: Wiring board; 04231: Wiring board hole; 0424: First conductive solder pad; 0425: Second conductive solder pad; 0426: Third conductive solder pad; 0427: Fourth conductive solder pad; 0428: Fifth conductive solder pad; 043: First telescoping assembly; 0431: First spring; 0432: First line fixing part; 04321: First mounting slot; 04322: First wiring board fixing column; 044: Second telescoping assembly; 0441: Second spring; 0442: Second line fixing part; 04421: Second mounting slot; 04422: Second wiring board fixing column;
050: Live line conducting assembly; 051: First live line conducting piece; 052: PCB live line gripper; 053: Second live line conducting piece; 054: First live line gripper; 055: European-standard live line gripper; 056: Protective gripper; 057: British-standard live line gripper; 058: Chinese-standard or Australian-standard live line gripper;
060: Zero line conducting assembly; 061: First zero line conducting piece; 062: PCB zero line gripper; 063: Second zero line conducting piece; 064: First zero line gripper; 065: European-standard zero line gripper; 066: British-standard zero line gripper; 067: Chinese-standard or Australian-standard zero line gripper;
070: Protective tube;
080: British-standard pin assembly; 081: British-standard button; 082: British-standard live line pin; 083: British-standard live line conducting piece; 084: British-standard zero line pin; 085: British-standard zero line conducting piece;
090: Chinese-standard or Australian-standard pin assembly; 091: Chinese-standard or Australian-standard button; 092: Chinese-standard or Australian-standard live line pin; 093: Chinese-standard or Australian-standard live line conducting piece; 094: Chinese-standard or Australian-standard zero line pin; 095: Chinese-standard or Australian-standard zero line conducting piece;
100: Housing; 101: Line accommodating groove; 102: Fixing and accommodating groove; 1021: Fixing-part accommodating groove; 1022: Fixing and clamping groove; 1023: Clamping block; 103: Handle groove;
110: Fixing and accommodating part; 1101: Fixing part; 1102: Clamping part; 11021: First clamping structure; 11022: Second clamping structure; 11023: Third clamping structure; 1103: Limiting part.

### EMBODIMENTS

To further illustrate the technical means adopted in the present disclosure for achieving predetermined object, and the effects thereof, embodiments of the present disclosure will be explained in detail with reference to the drawings and preferable examples.

In the description of the present invention, it should be understood that locations or position relationships indicated by “length”, “width”, “on/up”, “under/down”, “front”, “behind”, “left”, “right”, “vertical”, “horizontal”, “top”, “bottom”, “inside”, “outside” and other terms are the locations or position relationships indicated based on the drawings, and are merely for the convenience of describing the present disclosure and simplifying the description, rather than indicating or implying that the apparatus or element has to be in a specific location, or configured or operated at a specific location, and thus should not be understood as limits to the present disclosure.

Besides, the terms “first” and “second” are merely used for the purpose of description, and should not be understood as indication or implication of relative significance, or implicit indication of the number of indicated technical features. As a result, features limited by “first” and “second” may clearly or implicitly indicate one or more of such features. Unless otherwise specified, the term “plural” in the description of the present disclosure refers to two or more.

Unless otherwise specified or limited, “mount”, “interconnect”, “connect”, “fix” and other terms in the present disclosure should be understood in a broad sense, for instance, the parts can be fixedly or detachably connected, or can be integrated as one piece; they can be in mechanical or electric connection; they can be directly connected, and can also be indirectly connected via an intermediation, or can be a connection inside two elements or the interaction of two elements. For one skilled in the art, the meaning of the afore-mentioned terms in the present disclosure can be understood according to specific situations.

### Example I

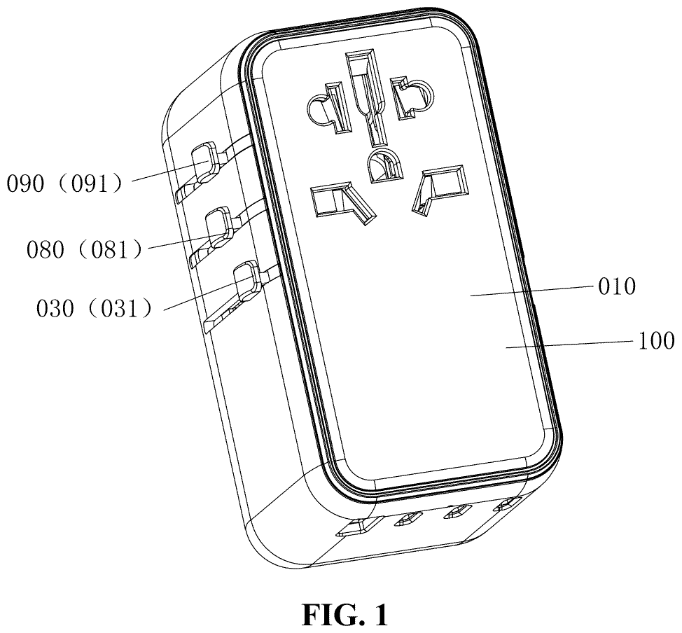

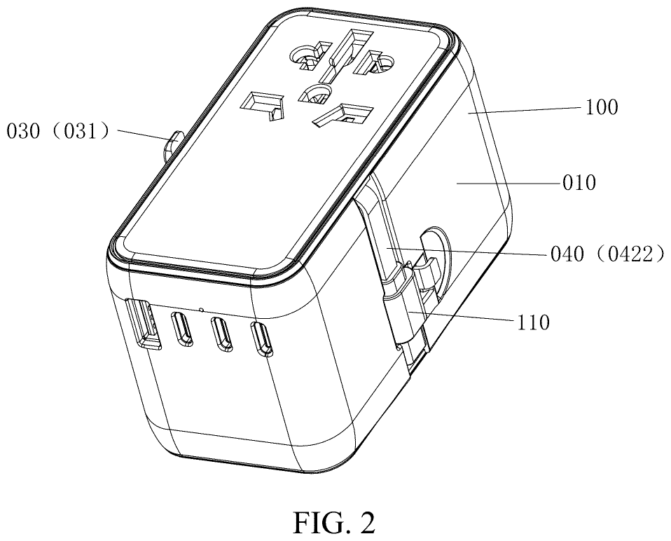

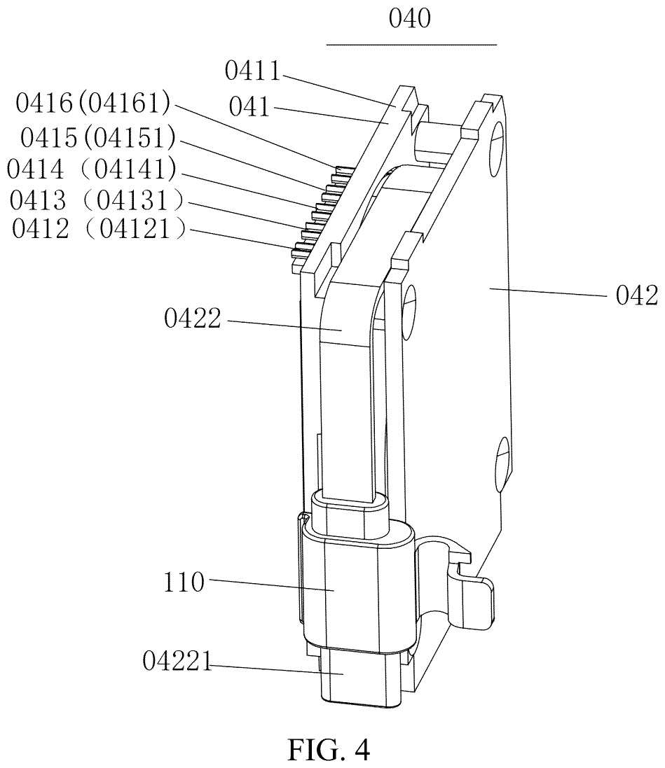

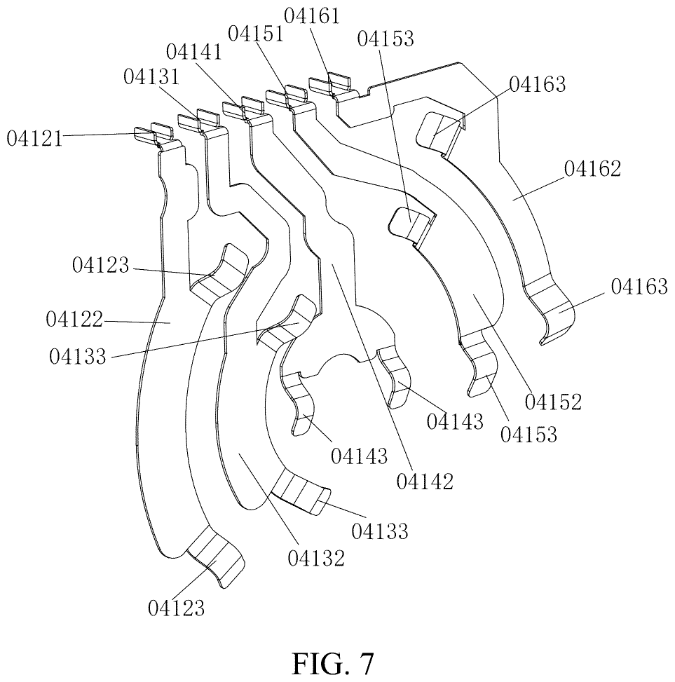

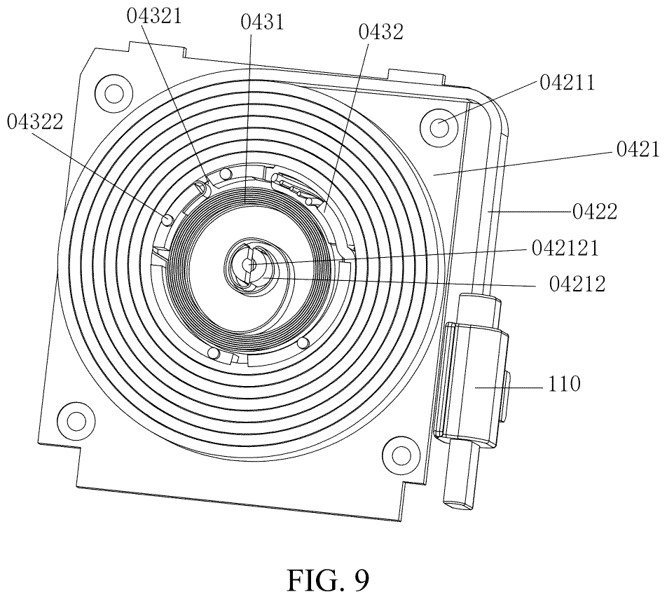

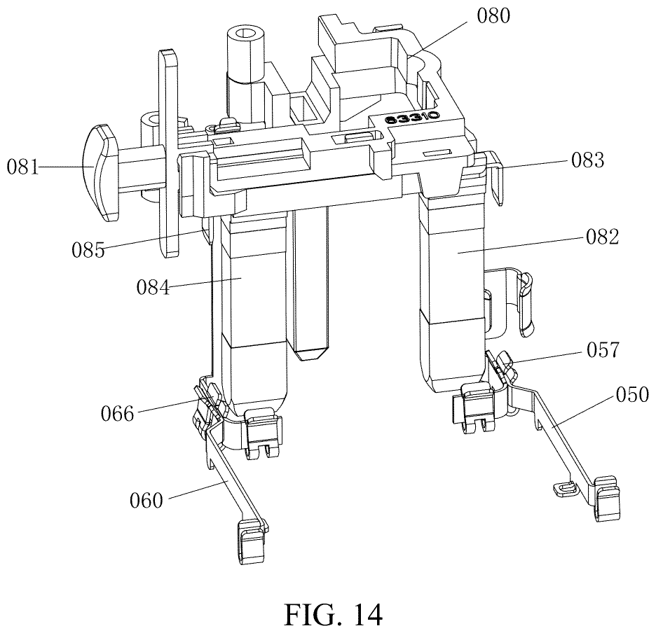

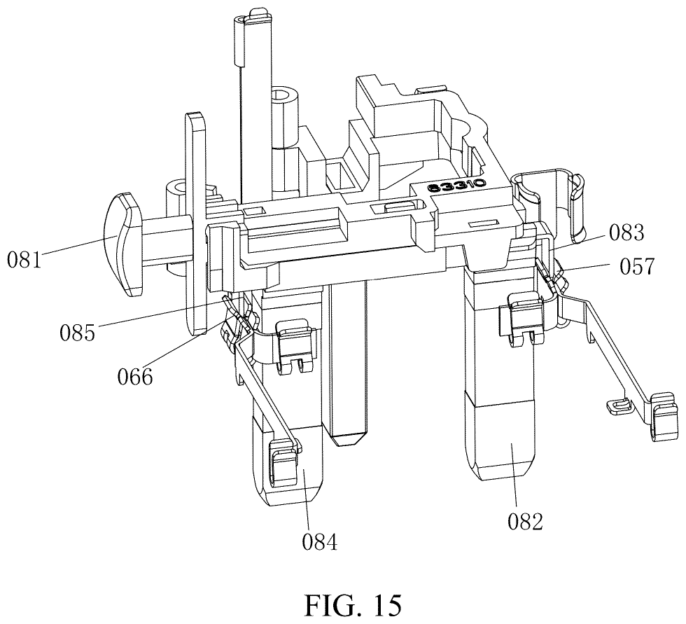

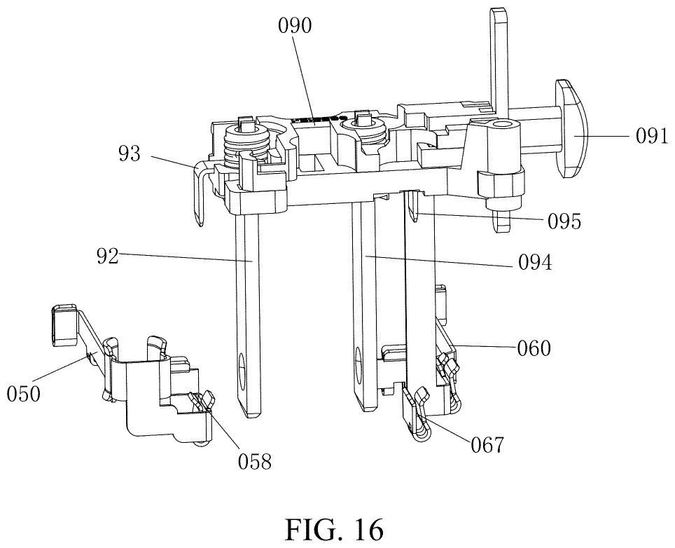

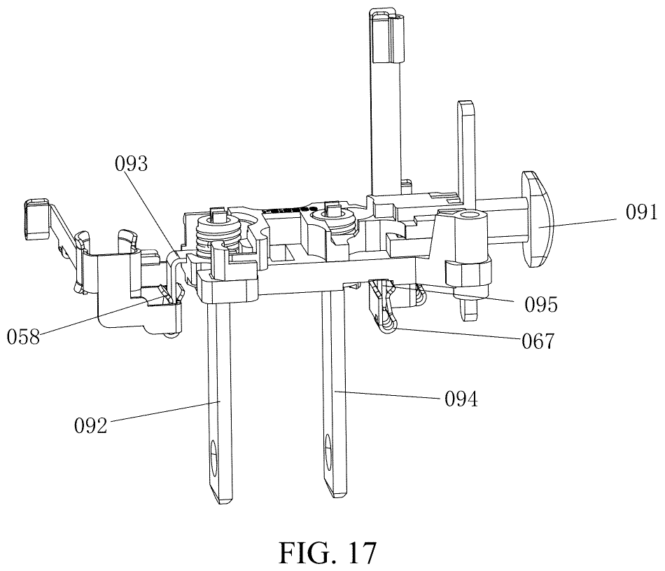

With reference to FIG. 1 to FIG. 23, the present example provides a power source converter having a data telescoping line, comprising a power source converter body 010 and a PCB 020 provided in the power source converter body 010, and further comprising a European-standard pin assembly 030 provided in the power source converter body 010, and a data line rotating and connecting device 040 that is provided between the PCB 020 and the European-standard pin assembly 030 and is in electric connection to the PCB 020; wherein: the data line 0422 rotating and connecting device 040 comprises a first terminal assembly 041, and a second terminal assembly 042 rotatably provided on the first terminal assembly 041; the first terminal assembly 041 comprises a first terminal fixing plate 0411, and plural conductive terminals (0412, 0413, 0414, 0415, 0416) embedded in the first terminal fixing plate 0411; the second terminal assembly 042 comprises a second terminal fixing plate 0421 that covers and fits the first terminal fixing plate 0411, a data line 0422 rotatably provided between the first terminal fixing plate 0411 and the second terminal fixing plate 0421, and a wiring board 0423 that is in electric connection to the data line 0422 and is positioned between the data line 0422 and the first terminal fixing plate 0411; the wiring board 0423 is provided with plural conductive solder pads (0424, 0425, 0426, 0427, 0428) that match, abut against and conduct with the conductive terminals (0412, 0413, 0414, 0415, 0416); and at least one conducting part (04123, 04133, 04143, 04153, 04163) is provided on the conductive terminals (0412, 0413, 0414, 0415, 0416), and the conducting part (04123, 04133, 04143, 04153, 04163) abuts against the conductive solder pads (0424, 0425, 0426, 0427, 0428).

The power source converter is provided to comprise a power source converter body 010, and a PCB 020 provided in the power source converter body 010, and further comprise a European-standard pin assembly 030 provided in the power source converter body 010, and a data-line rotating and connecting device 040, which is provided between the PCB 020 and the European-standard pin assembly 030 and is in electric connection to PCB 020; the data-line rotating and connecting device 040 is provided in the power source converter and is in electric connection to PCB 020; and a joint described hereinafter protrudes out of the power source converter body 010, as a result, people can pull the data line 0422 out of the data-line rotating and connecting device 040 so as to directly charge a phone, a tablet or the like, which avoids the trouble of arranging an extra plug that connects to the data line 0422 for power source conversion, and saves space. The data-line rotating and connecting device 040 is transversely provided between the PCB 020 and the European-standard pin assembly 030, so that the space of the data-line rotating and connecting device 040 in the power source converter body 010 is rationalized, and the problem of affecting the operation of other pins in the power source converter body 010 can be avoided, thereby making the power source converter small and portable.

The data line 0422 rotating and connecting device 040 is provided to comprise a first terminal assembly 041 and a second terminal assembly 042 rotatably provided on the first terminal assembly 041; the first terminal assembly 041 comprises a first terminal fixing plate 0411, and plural conductive terminals (0412, 0413, 0414, 0415, 0416) embedded in the first terminal fixing plate 0411; the second terminal assembly 042 comprises a second terminal fixing plate 0421 that covers and fits the first terminal fixing plate 0411, a data line 0422 rotatably provided between the first terminal fixing plate 0411 and the second terminal fixing plate 0422, and a wiring board 0423 that is in electric connection to the data line 0422 and is positioned between the data line 0422 and the first terminal fixing plate 0411; the wiring board 0423 is provided with plural conductive solder pads (0424, 0425, 0426, 0427, 0428) that match, abut against and conduct with the conductive terminals; and at least one conducting part (04123, 04133, 04143, 04153, 04163) is provided on the conductive terminals (0424, 0425, 0426, 0427, 0428), and the connecting part (04123, 04133, 04143, 04153, 04163) abuts against the conductive solder pads (0424, 0425, 0426, 0427, 0428). When the data line 0422 is needed and is pulled by people, it can rotate with the first terminal fixing plate 0411 or the second terminal fixing plate 0421 as an axis and drive the wiring board 0423 to rotate together; while being rotated, the conductive terminals (0412, 0413, 0414, 0415, 0416) stably abut against corresponding conductive solder pads (0424, 0425, 0426, 0427, 0428) on the wiring board 0423, and thus realizes stable conduction between the data line 0422 connected to the wiring board 0423 and conductive terminals (0412, 0413, 0414, 0415, 0416), fixed conduction between conductive terminals (0412, 0413, 0414, 0415, 0416) and PCB 020, and the conduction between PCB 020 and an external power source, thereby realizing stable conduction between the data line 0422 and the external power source. After molding, the conductive terminals (0412, 0413, 0414, 0415, 0416) are placed into the mold of the first terminal fixing plate 0411, which is molded by means of direct injection, as a result, conductive terminals (0412, 0413, 0414, 0415, 0416) are stably embedded in the first terminal fixing plate 0411 and will not be displaced, thereby avoiding the normal conduction failure caused by displacement of conductive terminals (0412, 0413, 0414, 0415, 0416) driven by the second terminal assembly 042. The present power source converter has a simple and clear overall structure, low production cost, and stable conduction during rotation, and thus is highly practical.

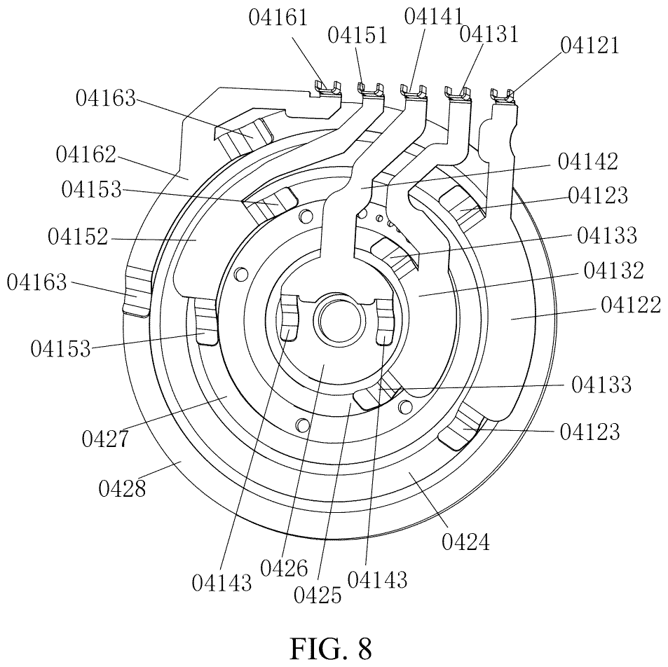

Preferably, as shown in FIG. 8, the conductive solder pads (0424, 0425, 0426, 0427, 0428) are concentrically provided, so that the conductive terminals (0412, 0413, 0414, 0415, 0416) can better abut against and conduct with conductive solder pads (0424, 0425, 0426, 0427, 0428) during rotation, which is good for balancing supporting force and enhancing conduction stability.

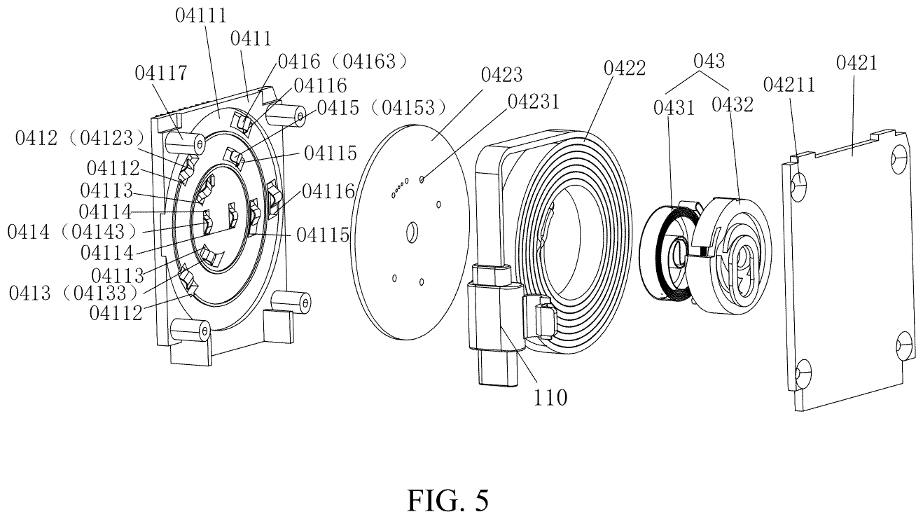

To realize fast charge, as showing in FIGS. 5 to 8, both the conductive terminals and the conductive solder pads are in 5 sets; the conductive terminals are respectively: a first conductive terminal 0412 embedded in the first terminal fixing plate 0411, a second conductive terminal 0413 embedded in the first terminal fixing plate 0411, a third conductive terminal 0414 embedded in the first terminal fixing plate 0411, a fourth conductive terminal 0415 embedded in the first terminal fixing plate 0411, and a fifth conductive terminal 0416 embedded in the first terminal fixing plate 0411; and the conductive solder pads are respectively: a first conductive solder pad 0424, a second conductive solder pad 0425, a third conductive solder pad 0426, a fourth conductive solder pad 0427, and a fifth conductive solder pad 0428. The first conductive terminal 0412 correspondingly abuts against the first conductive solder pad 0424 so as to conduct with the first conductive solder pad 0424, the second conductive terminal 0413 correspondingly abuts against the second conductive solder pad 0425 so as to conduct with the second conductive solder pad 0425, the third conductive terminal 0414 correspondingly abuts against the third conductive solder pad 0426 so as to conduct with the third conductive solder pad 0426, the fourth conductive terminal 0415 correspondingly abuts against the fourth conductive solder pad 0427 so as to conduct with the fourth conductive solder pad 0427, and the fifth conductive terminal 0416 correspondingly abuts against the fifth conductive solder pad 0428 so as to conduct with the fifth conductive solder pad 0428, as a result, the present power source converter is effectively compatible and can be shared by 2, 3, 4 or 5 solder pads, thereby realizing 5-pin fast charge, realizing the function of sensing CC pin position and OTG, and solving the problem in the prior art where the CC pin function of a rotating connector is limited.

As for the specific structure arrangement of the first conductive terminal 0412, as shown in FIGS. 5 to 8, the first conductive terminal 0412 comprises a first wiring board connecting end 04121 extending to one side outside the first terminal fixing plate 0411 and away from the wiring board 0423, a first conducting piece 04122 connected to the first wiring board connecting end 04121 and matching the first conductive solder pad 0424, and at least one first conducting part 04123 that is formed on the first conducting piece 04122 and is bent to abut against the first conductive solder pad 0424. The first wiring board connecting end 04121 extends out of the first terminal fixing plate 0411 while the first terminal fixing plate 0411 is molded by injection, so as to be connected to the PCB 020. The first conducting piece 04122 has a shape matching the first conductive solder pad 0424, the first conductive solder pad 0424 has a shape of hollow concentric circle, the first conducting piece 04122, as a whole, has a shape of curved runway so as to match the shape of the first conductive solder pad 0424, as a result, the first conducting part 04123 provided on the first conducting piece 04122 can better abut against the first conductive solder pad 0424, and thus avoid the problem where the first conducting part 04123 fails to abut against and conduct with the first conductive solder pad 0424 when the first conductive solder pad 0424 is driven to rotate.

As for the specific structure arrangement of the second conductive terminal 0413, as shown in FIGS. 5 to 8, the second conductive terminal 0413 comprises a second wiring board connecting end 04131 extending to one side outside the first terminal fixing plate 0411 and away from the wiring board 0423, a second conducting piece 04132 connected to the second wiring board connecting end 04131 and matching the second conductive solder pad 0425, and at least one second conducting part 04133 that is formed on the second conducting piece 04132 and is bent to abut against the second conductive solder pad 0425. The second wiring board connecting end 04131 extends out of the first terminal fixing plate 0411 while the first terminal fixing plate 0411 is molded by injection, so as to be connected to the PCB 020. The second conducting piece 04132 has a shape matching the second conductive solder pad 0425, the second conductive solder pad 0425 has a shape of hollow concentric circle, and the second conducting piece 04132, as a whole, has a shape of curved runway so as to match the shape of the second conductive solder pad 0425, as a result, the second conducting part 04133 provided on the second conducting piece 04123 can better abut against the second conductive solder pad 0425, and thus avoid the problem where the second conducting part 04133 fails to abut against and conduct with the second conductive solder pad 0425 when the second conductive solder pad 0425 is driven to rotate. The second conducting piece 04132 can also be provided with a second bending position for evading the first conducting part 04123 and other components, and the specific number and bending manner of the second bending position can be provided according to the specific application of the present power source converter, and will not be specifically limited in this example.

As for the specific structure arrangement of the third conductive terminal 0414, as shown in FIGS. 5 to 8, the third conductive terminal 0414 comprises a third wiring board connecting end 04141 extending to one side outside the first terminal fixing plate 0411 and away from the wiring board 0423, a third conducting piece 04142 connected to the third wiring board connecting end 04141 and matching the third conductive solder pad 0426, and at least one third conducting part 04143 that is formed on the third conducting piece 04142 and is bent to abut against the third conductive solder pad 0426. The third wiring board connecting end 04141 extends out of the first terminal fixing plate 0411 while the first terminal fixing plate 0411 is molded by injection, so as to be connected to the PCB 020. The third conducting piece 04142 has a shape matching the third conductive solder pad 0426, the third conductive solder pad 0426 has a shape of hollow concentric circle, the third conducting piece 04142, as a whole, has a shape of curved runway so as to match the shape of the third conductive solder pad 0426, as a result, the third conducting part 04143 provided on the third conducting piece 04123 can better abut against the third conductive solder pad 0426, and thus avoid the problem where the third conducting part 04143 fails to abut against and conduct with the third conductive solder pad 0426 when the third conductive solder pad 0426 is driven to rotate. The third conducting piece 04142 can also be provided with a third bending position for evading the second conducting part 04133 and other components, and the specific number and bending manner of the third bending position can be provided according to the specific application of the present power source converter, and will not be specifically limited in this example.

As for the specific structure arrangement of the fourth conductive terminal 0415, as shown in FIGS. 5 to 8, the fourth conductive terminal 0415 comprises a fourth wiring board connecting end 04151 extending to one side outside the first terminal fixing plate 0411 and away from the wiring board 0423, a fourth conducting piece 04152 connected to the fourth wiring board connecting end 04151 and matching the fourth conductive solder pad 0427, and at least one fourth conducting part 04153 that is formed on the fourth conducting piece 04152 and is bent to abut against the fourth conductive solder pad 0427. The fourth wiring board connecting end 04151 extends out of the first terminal fixing plate 0411 while the first terminal fixing plate 0411 is molded by injection, so as to be connected to the PCB 020. The fourth conducting piece 04152 has a shape matching the fourth conductive solder pad 0427, the fourth conductive solder pad 0427 has a shape of hollow concentric circle, the fourth conducting piece 04152, as a whole, has a shape of curved runway so as to match the shape of the fourth conductive solder pad 0427, as a result, the fourth conducting part 04153 provided on the fourth conducting piece 04153 can better abut against the fourth conductive solder pad 0427, and thus avoid the problem where the fourth conducting part 04153 fails to abut against and conduct with the fourth conductive solder pad 0427 when the fourth conductive solder pad 0427 is driven to rotate. The fourth conducting piece 04152 can also be provided with a fourth bending position for evading the third conducting part 04143 and other components, and the specific number and bending manner of the fourth bending position can be provided according to the specific application of the present power source converter, and will not be specifically limited in this example.

As for the specific structure arrangement of the fifth conductive terminal 0416, as shown in FIGS. 5 to 8, the fifth conductive terminal 0416 comprises a fifth wiring board connecting end 04161 extending to one side outside the first terminal fixing plate 0411 and away from the wiring board 0423, a fifth conducting piece 04162 connected to the fifth wiring board connecting end 04161 and matching the fifth conductive solder pad 0428, and at least one fifth conducting part 04163 that is formed on the fifth conducting piece 04162 and is bent to abut against the fifth conductive solder pad 0428. The fifth wiring board connecting end 04161 extends out of the first terminal fixing plate 0411 while the first terminal fixing plate 0411 is molded by injection, so as to be connected to the PCB 020. The fifth conducting piece 04162 has a shape matching the fifth conductive solder pad 0428, the fifth conductive solder pad 0428 has a shape of hollow concentric circle, the fifth conducting piece 04162, as a whole, has a shape of curved runway so as to match the shape of the fifth conductive solder pad 0428, as a result, the fifth conducting part 04163 provided on the fifth conducting piece 04163 can better abut against the fifth conductive solder pad 0428, and thus avoid the problem where the fifth conducting part 04163 fails to abut against and conduct with the fifth conductive solder pad 0428 when the fifth conductive solder pad 0428 is driven to rotate. The fifth conducting piece 04162 can also be provided with a fifth bending position for evading the fourth conducting part 04153 and other components, and the specific number and bending manner of the fifth bending position can be provided according to the specific application of the present power source converter, and will not be specifically limited in this example.

Preferably, as shown in FIGS. 5 to 8, the first conducting parts 04123, the second conducting parts 04133, the third conducting parts 04143, the fourth conducting parts 04153, and the fifth conducting parts 04163 are all in two sets. One set of the first conducting part 04123 is provided at the lower end of the first conducting piece 04122, so as to closely abut against the bottom side of the first conductive solder pad 0424, while the other set of the first conducting part 04123 is provided at the middle of the first conducting piece 04122 where the runway shape starts to bend, so as to closely abut against the top side of the first conductive solder pad 0424; the two sets of first conducting parts 04123 are provided to fit the shape of the first conducting piece 04122, and make it even easier for the first conductive terminal 0412 to conduct with the first conductive solder pad 0424 while the first conductive solder pad 0424 is rotated, thereby realizing stable connection. One set of the second conducting part 04133 is provided at the lower end of the second conducting piece 04132, so as to closely abut against the bottom side of the second conductive solder pad 0425, while the other set of the second conducting part 04133 is provided at the middle of the second conducting piece 04132 where the runway shape starts to bend, so as to closely abut against the top side of the second conductive solder pad 0425; the two sets of second conducting parts 04133 are provided to fit the shape of the second conducting piece 04132, and make it even easier for the second conductive terminal 0413 to conduct with the second conductive solder pad 0425 when the second conductive solder pad 0425 is rotated, thereby realizing stable connection. Two sets of the third conducting parts 04143 are correspondingly provided at lower ends of the third conducting piece 04142, so that the third conducting parts 04143 can better and correspondingly abut against the two sides of the third conductive solder pad 0426, thereby realizing conduction and stable connection. One set of the fourth conducting part 04153 is provided at the lower end of the fourth conducting piece 04152, so as to closely abut against the bottom side of the fourth conductive solder pad 0427, while the other set of the fourth conducting part 04153 is provided at the middle of the fourth conducting piece 04152 where the runway shape starts to bend, so as to closely abut against the top side of the fourth conductive solder pad 0427; the two sets of the fourth conducting parts 04153 are provided to fit the shape of the fourth conducting piece 04152, and make it even easier for the fourth conductive terminal 0415 to conduct with the fourth conductive solder pad 0427 while the fourth conductive solder pad 0427 is rotated, thereby realizing stable connection. One set of the fifth conducting part 04163 is provided at the lower end of the fifth conducting piece 04162, so as to closely abut against the bottom side of the fifth conductive solder pad 0428, while the other set of the fifth conducting part 04163 is provided at the middle of the fifth conducting piece 04162 where the runway shape starts to bend, so as to closely abut against the top side of the fifth conductive solder pad 0428; the two sets of the fifth conducting parts 04163 are provided to fit the shape of the fifth conducting piece 04162, and make it even easier for the fifth conductive terminal 0416 to conduct with the fifth conductive solder pad 0428 while the fifth conductive solder pad 0428 is rotated, thereby realizing stable connection.

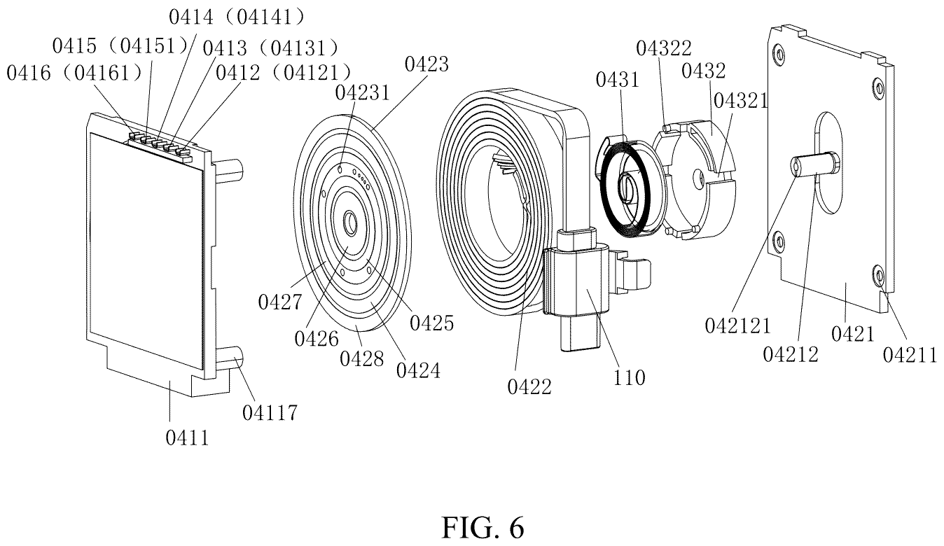

As for the specific structure of the first terminal fixing plate 0411, as shown in FIGS. 5 to 6, a middle part of the first terminal fixing plate 0411 is provided with a mounting slot 04111 for wiring and conduction, into which the wiring board 0423 can be embedded, wherein the wiring board 0423 is correspondingly embedded and mounted into the mounting slot 04111 for wiring and conduction, and is driven to rotate in the mounting slot 04111 for wiring and conduction by a data line 0422. The mounting slot 04111 for wiring and conduction is provided with: at least one first conducting slot 04112, through which the first conducting part 04123 stretches to abut against the first conductive solder pad 0424, at least one second conducting slot 04113, through which the second conducting part 04133 stretches to abut against the second conductive solder pad 0425, at least one third conducting slot 04114, through which the third conducting part 04143 stretches to abut against the third conductive solder pad 0426, at least one fourth conducting slot 04115, through which the fourth conducting part 04153 stretches to abut against the fourth conductive solder pad 0427, and at least one fifth conducting slot 04116, through which the fifth conducting part 04163 stretches to abut against the fifth conductive solder pad 0428; and four corners of the first terminal fixing plate 0411 are respectively provided with an integral mounting column 04117 extending towards the second terminal fixing plate 0421.

Preferably, as shown in FIGS. 5 to 6, the first conducting slot 04112, the second conducting slot 04113, the third conducting slot 04114, the fourth conducting slot 04115, and the fifth conducting slot 04116 are all in two sets. The first conducting slot 04112, the second conducting slot 04113, the third conducting slot 04114, the fourth conducting slot 04115, and the fifth conducting slot 04116 are provided and molded at the same time when the first terminal fixing plate 0411 is molded by means of injection, so that the first conducting part 04123 correspondingly stretches out of the first conducting slot 04112 to abut against the first conductive solder pad 0424, the second conducting part 04133 correspondingly stretches out of the second conducting slot 04113 to abut against the second conductive solder pad 0425, the third conducting part 04143 correspondingly stretches out of the third conducting slot 04114 to abut against the third conductive solder pad 0426, the fourth conducting part 04153 correspondingly stretches out of the fourth conducting slot 04115 to abut against the fourth conductive solder pad 0427, and the fifth conducting part 04163 correspondingly stretches out of the fifth conducting slot 04116 to abut against the fifth conductive solder pad 0428, thereby realizing stable conduction and connection between conductive terminals (0412, 0413, 0414, 0415, 0416) and conductive solder pads (0424, 0425, 0426, 0427, 0428) when the data line 0422 is rotating while it is pulled out.

As for the specific structure of the second terminal fixing plate 0421, as shown in FIGS. 5 to 6 and 9, four corners of the second terminal fixing plate 0421 are respectively provided with a mounting and fixing hole 04211, into which the integral mounting column 04117 stretches and is mounted, the integral mounting columns 04117 are correspondingly mounted into the mounting and fixing hole 04211, and the exterior of the mounting and fixing holes 04211 can also be reinforced and fixed by means of aligning bolts with mounting columns, thereby realizing stable connection between the first terminal fixing plate 0411 and the second terminal fixing plate 0421, and avoiding the failure to normally pull out and use the data line 0422 caused by synchronous rotation of the second terminal fixing plate 0421 while the data line 0422 is pulled out.

As for the specific rotation means of the second terminal assembly 042 with the first terminal assembly 041 as an axis, as shown in FIGS. 5 to 6 and 9, the second terminal fixing plate 0421 is formed with a first axis 04212 extending towards the first terminal assembly 041 in the middle, and the data line 0422 rotates around the axis while it is pulled out with the first axis 04212 as the axis.

As for the specific telescoping means of the data line 0422, as shown in FIGS. 5 to 6 and 9, a first telescoping assembly 043, of which a middle part is clamped into the first axis 04212 and an exterior is connected to the data line 0422, is further provided, wherein the first telescoping assembly 043 comprises a first spring 0431, a middle part of which is clamped into the first axis 04212, and a first line fixing part 0432 sleeving the first spring 0431 and embedded in the data line 0422. The top end of the first axis 04212 is provided with a mounting groove 042121 of the first spring 0431, and an inner side end of the first spring 0431 is embedded into the mounting groove 042121 of the first spring 0431. The first line fixing part 0432 is evenly provided with plural first mounting grooves 04321 at the outer side, and an innermost side of the data line 0422 is embedded into one set of first mounting grooves 04321, which realizes the connection between the data line 0422 and the first line fixing part 0432, and an outer side end of the first spring 0431 surrounds the outer side of the first line fixing part 0432 via another set of first mounting grooves 04321, thereby realizing connection between the first spring 0431 and the first line fixing part 0432. When the data line 0422 is pulled out by people, the data line 0422 drives the first line fixing part 0432 to rotate, and the first line fixing part 0432 drives the first spring 0431 to deform; when the data line 0422 is not needed, the first line fixing part 0432 and the data line 0422 rotate reversely under the elastic restoring force of the first spring 0431, thereby realizing the effect of retraction. The first telescoping assembly 043 may further comprise plural limiting bumps, balls and so on, so that the data line 0422 can be pulled out at equal intervals; such control means and structure are prior art and can be provided according to actual situation, and thus will not be repeated in this example.

As for the specific rotation means of the wiring board 0423, as shown in FIGS. 5 to 6 and 9, one side of the first line fixing part 0432 facing the wiring board 0423 is provided with at least one first wiring board fixing column 04322, the wiring board 0423 is provided with at least one wiring board hole 04231 matching the fixing column of the wiring board 0423, and the first wiring board fixing column 04322 is mounted into the wiring board hole 04231, so that the wiring board 0423 is driven to rotate at the same time when the first line fixing part 0432 is driven to rotate by the data line 0422.

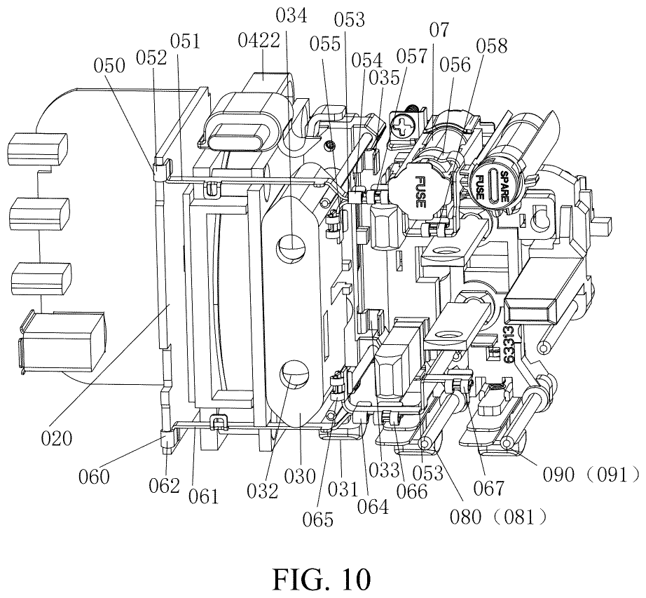

As for the specific conduction means of the present power source converter, as shown in FIGS. 10 to 17, the present power source converter further comprises a live line conducting assembly 050, which is provided on the PCB 020 and is in electric connection to the PCB 020, and a zero line conducting assembly 060, which is provided on the PCB 020 and is in electric connection to the PCB 020. When the European-standard pin assembly 030 is pulled out of the power source converter body 010 to be used, it is respectively in electric connection to the zero line conducting assembly 060 and the live line conducting assembly 050, thereby realizing power source conduction between the plug inserted externally and the European-standard pin assembly 030. The conduction of whole conduction structure is stable, and, besides the European-standard pin assembly 030, other pin assemblies can also be provided for conduction and connection, so as to make the power source converter more practical.

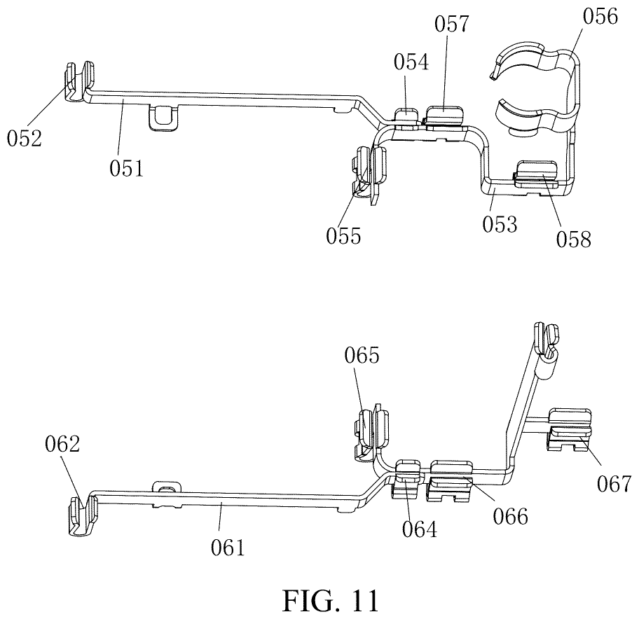

As for the specific structure of the live line conducting assembly 050, as shown in FIGS. 10 and 11, the live line conducting assembly 050 comprises: a first live line conducting piece 51, a PCB live line gripper 052 formed at one end of the first live line conducting piece 051 and gripping the PCB 020, a second live line conducting piece 053, a first live line gripper 054 formed at one end of the second live line conducting piece 053 close to the first live line conducting piece 051 and gripping the other end of the first live line conducting piece 051, and a European-standard live line gripper 055 provided at one side of the second live line conducting piece 053 close to the European-standard pin assembly 030. The first live line gripper 054 is provided to grip the first live line conducting piece 051, so that the first live line conducting piece 051 and the second live line conducting piece 053 are in electric connection.

As for the specific structure of the zero line conducting assembly 060, as shown in FIGS. 10 and 11, the zero line conducting assembly 060 comprises: a first zero line conducting piece 061, a PCB zero line gripper 062 formed at one end of the first zero line conducting piece 061 and gripping the PCB 020, a second zero line conducting piece 063, a first zero line gripper 064 formed at one end of the second zero line conducting piece 063 close to the first zero line conducting piece 061 and gripping the other end of the first zero line conducting piece 061, and a European-standard zero line gripper 065 provided at one side of the second zero line conducting piece 063 close to the European-standard pin assembly 030. The PCB zero line gripper 062 is provided to grip the PCB 020, so that the PCB 020 and the first zero line conducting piece 061 are in electric connection. The first zero line gripper 064 is provided to grip the first zero line conducting piece 061, so that the first zero line conducting piece 061 and the second zero line conducting piece 063 are in electric connection.

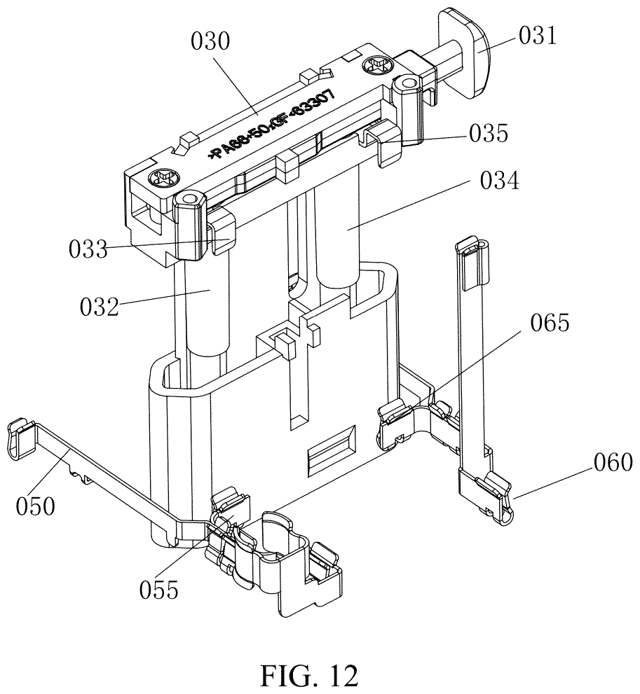

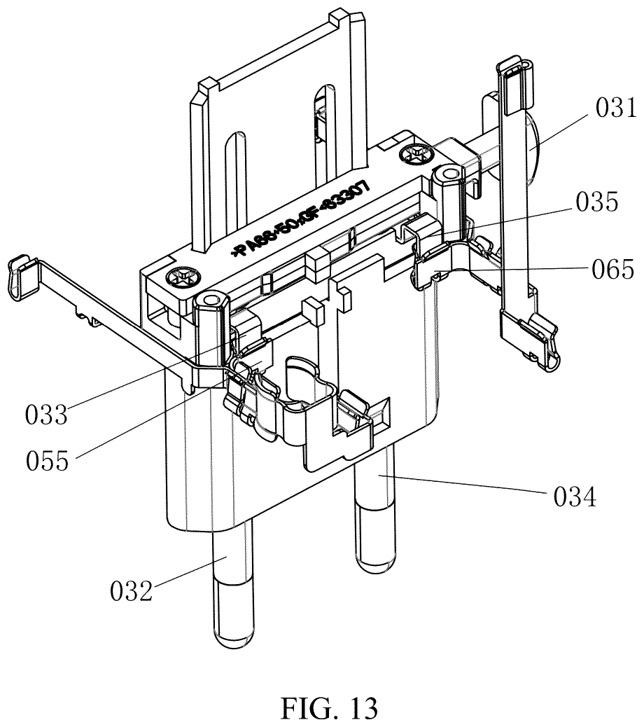

As for the specific structure of the European-standard pin assembly 030, as shown in FIGS. 12 to 13, the European-standard pin assembly 030 comprises: a European-standard button 031 provided in the power source converter body 010, a European-standard live line pin 032 provided on the European-standard button 031, a European-standard live line conducting piece 033 provided between the European-standard live line pin 032 and the European-standard button 031 and facing the European-standard live line gripper 055, a European-standard zero line pin 034 provided on the European-standard button 031, and a European-standard zero line conducting piece 035 provided between the European-standard zero line pin 034 and the European-standard button 031 and facing the European-standard zero line gripper 065. When people need to use the European-standard pin assembly 030, they only need to press the European-standard button 031 to pull out the European-standard pin assembly 030 towards the power source converter body 010, and pull the European-standard live line pin 032 and the European-standard zero line pin 034 out of the power source converter body 010, thereby realizing conversion of the European-standard pin. When the European-standard live line pin 032 and the European-standard zero line pin 034 are pushed out, the European-standard live line conducting piece 033 provided on the European-standard live line pin 032 and the European-standard zero line conducting piece 035 provided on the European-standard zero line pin 034 are synchronously moved outwards, so that the European-standard live line conducting piece 033 is inserted into the European-standard live line gripper 055 so as to realize the electric connection between the European-standard pin assembly 030 and the live line conducting assembly 050, and the European-standard zero line conducting piece 035 is inserted into the European-standard zero line gripper 065 so as to realize the electric connection between the European-standard pin assembly 030 and the zero line conducting assembly 060, thereby further realizing electric connection between the European-standard pin assembly 030 and the plug inserted into the power source converter body 010; moreover, the conduction is stable during the whole process, and the conduction is more efficient.

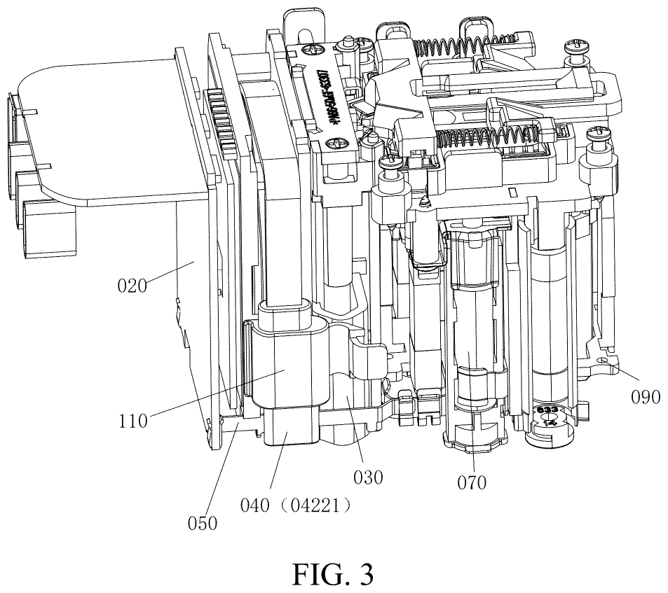

To enhance security of the present power source converter, as shown in FIGS. 3 and 10, a protective tube 070 provided in the power source converter body 010 is further comprised, the live line conducting assembly 050 further comprises a protective gripper 056 that is formed on one side of the second live line conducting piece 053 away from the European-standard pin assembly 030 and gripping the protective tube 070, and a middle part of the protective tube 070 is gripped via the protective gripper 056, as a result, the live line conducting assembly 050 is in electric connection to the protective tube 070; the protective tube 070 can cut off the current by self-fusing when the current is abnormally high, and thus can play the role of protection and enhance security of the power source converter.

To make the power source converter more practical, as shown in FIGS. 10, 14 and 15, a British-standard pin assembly 080 provided in the power source converter body 010 is further comprised, wherein the British-standard pin assembly 080 comprises: a British-standard button 081, a British-standard live line pin 082 provided on the British-standard button 081, a British-standard live line conducting piece 083 provided between the British-standard live line pin 082 and the British-standard button 081, a British-standard zero line pin 084 provided under the British-standard button 081, and a British-standard zero line conducting piece 085 provided between the British-standard zero line pin 084 and the British-standard button 081.

As for the specific conduction means of the British-standard pin assembly 080 respectively with the live line conducting assembly 050 and the zero line conducting assembly 060, as shown in FIGS. 10, 14 and 15, the second live line conducting piece 053 is further provided with a British-standard live line gripper 057 facing the British-standard live line conducting piece 083, and the second zero line conducting piece 063 is further provided with a British-standard zero line gripper 066 facing the British-standard zero line conducting piece 085.

As shown in FIGS. 10, 14 and 15, when people need to use the British-standard pin assembly 080, they only need to press the British-standard button 081 to push the British-standard pin assembly 080 towards exterior of the power source converter body 010, so that the British-standard live line pin 082 and the British-standard zero line pin 084 are pushed out of the power source converter body 010 for conversion of British-standard pin. When the British-standard live line pin 082 and the British-standard zero line pin 084 are pushed out, the British-standard live line conducting piece 083 provided on the British-standard live line pin 082 and the British-standard zero line conducting piece 085 provided on the British-standard zero line pin 084 are synchronously moved outwards, so that the British-standard live line conducting piece 083 is inserted into the British-standard live line gripper 057, thereby realizing electric connection between the British-standard pin assembly 080 and the live line conducting assembly 050, and the British-standard zero line conducting piece 085 is inserted into the British-standard zero line gripper 066, thereby realizing electric connection between the British-standard pin assembly 080 and the zero line conducting assembly 060, and thus electric connection between the British-standard pin assembly 080 and the plug inserted into the power source converter body 010, the conduction during the whole process, and interconversion of different pins are realized, as a result of which the application scope of the present power source converter is broadened and the present power source converter is more practical.

To make the present power source converter more practical, as shown in FIGS. 10, 16 and 17, a Chinese-standard or Australian-standard pin assembly 090 provided in the power source converter body 010 is further provided, wherein the Chinese-standard or Australian-standard pin assembly 090 further comprises: a Chinese-standard or Australian-standard button 091, a Chinese-standard or Australian-standard live line pin 092 provided on the Chinese-standard or Australian-standard button 091, a Chinese-standard or Australian-standard live line conducting piece 093 provided between the Chinese-standard or Australian-standard live line pin 092 and the Chinese-standard or Australian-standard button 091, a Chinese-standard or Australian-standard zero line pin 094 provided on the Chinese-standard or Australian-standard, and a Chinese-standard or Australian-standard zero line conducting piece 095 provided between the Chinese-standard or Australian-standard zero line pin 094 and the Chinese-standard or Australian-standard button 091.

As for the specific conduction means of the Chinese-standard or Australian-standard pin assembly 090 respectively with the live line conducting assembly 050 and the zero line conducting assembly 060, as shown in FIGS. 10, 16 and 17, the second live line conducting piece 053 is further provided with a Chinese-standard or Australian-standard live line gripper 058 facing the Chinese-standard or Australian-standard live line conducting piece 093, and the second zero line conducting piece 063 is further provided with a Chinese-standard or Australian-standard zero line gripper 067 facing the Chinese-standard or Australian-standard zero line conducting piece 095.

As shown in FIGS. 10, 16 and 17, when people need to use the Chinese-standard or Australian-standard pin assembly 090, they only need to press the Chinese-standard or Australian-standard button 091 to push the Chinese-standard or Australian-standard pin assembly 090 towards exterior of the power source converter body 010, so that the Chinese-standard or Australian-standard live line pin 092 and the Chinese-standard or Australian-standard zero line pin 094 are pushed out of the power source converter body 010 for conversion of the Chinese-standard or Australian-standard pin. When the Chinese-standard or Australian-standard live line pin 092 and the Chinese-standard or Australian-standard zero line pin 094 are pushed out, the Chinese-standard or Australian-standard live line conducting piece 093 provided on the Chinese-standard or Australian-standard live line pin 092 and the Chinese-standard or Australian-standard zero line conducting piece 095 provided on the Chinese-standard or Australian-standard zero line pin 094 are synchronously moved outwards, so that the Chinese-standard or Australian-standard live line conducting piece 093 is inserted into the Chinese-standard or Australian-standard live line gripper 058, thereby realizing electric connection between the Chinese-standard or Australian-standard pin assembly 090 and the live line conducting assembly 050, and the Chinese-standard or Australian-standard zero line conducting piece 095 is inserted into the Chinese-standard or Australian-standard zero line gripper 067, thereby realizing electric connection between the Chinese-standard or Australian-standard pin assembly 090 and the zero line conducting assembly 060, and thus the electric connection between the European-standard pin and the plug inserted into the power source converter body 010, the conduction during the whole process, and interconversion of different pins are realized, as a result of which the application scope of the present power source converter is broadened and the present power source converter is more practical.

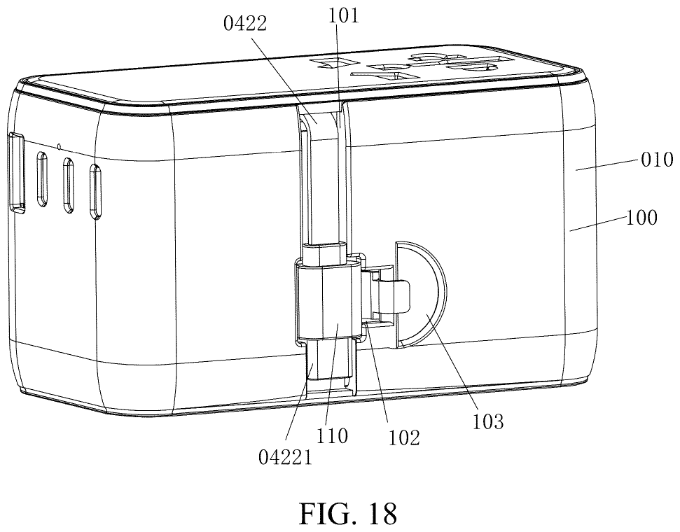

As for the accommodating means of the data line 0422 out of the power source converter, as shown in FIGS. 18 to 21, the power source converter body 010 further comprises a housing 100, and an outermost end of the data line 0422 is provided with an interface 04221, wherein: the interface 04221 is sleeved with a fixing and accommodating part 110, and the housing 100 is provided with a line accommodating groove 101 matching the data line 0422, and a fixing and accommodating groove 102 formed in the line accommodating groove 101 and matching the fixing and accommodating part 110. Part of the data line 0422 exposed out of the power source converter body 010 is accommodated into the line accommodating groove 101, and the interface 04221 of the data line 0422 and the fixing and accommodating part 110 are clamped into the fixing and accommodating groove 102, as a result of which the interface of the data line 0422 is fixed onto the housing 100 of the power source converter body 010 via the fixing and accommodating part 110, the interface 04221 of the data line 0422 is prevented from being damaged by exterior collision or intertwining with other objects when it is displaced, space for placing the data line 0422 and the interface 04221 can be saved, and the power source converter can be more easily used when people go out.

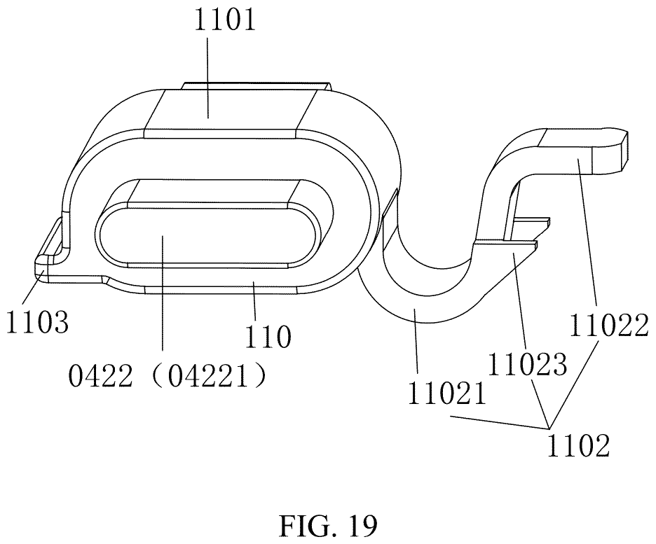

As for the specific structure of the fixing and accommodating part 110, as shown in FIG. 19, the fixing and accommodating part 110 comprises a fixing part 1101 sleeving the data line 0422 and having a hollow and flat shape as a whole, an all-in-one clamping part 1102 formed at one side of the fixing part 1101, and an all-in-one limiting part 1103 formed at the other side of the fixing part 1101. The fixing part 1101 is provided to sleeve the data line 0422, so that the fixing and accommodating part 110 is fixed onto the data line 0422. The clamping part 1102 is provided, and is clamped in the fixing and accommodating groove 102, so that the fixing and accommodating part 110 drives the data line 0422 to be clamped at a side edge of the housing 100. A limiting part 1103 is further provided at one side of the fixing part 1101, and the limiting part 1103 is clamped into one end of the fixing and accommodating groove 102 away from the clamping part 1102 so as to fit the clamping part 1102 for the limiting the left and right sides, as a result, the fixing and accommodating part 110 can be better placed into the fixing and accommodating groove 102, thereby realizing accommodating of the joint of the data line 0422.

As for the specific structure of the limiting part 1103, as shown in FIG. 19, the limiting part 1103, as a whole, takes a block shape extending outwards, and the block structure can be more easily aligned with the fixing and accommodating groove 102 for precise limiting, thereby realizing precise clipping.

As for the specific structure of the clamping part 1102, as shown in FIG. 19, the clamping part 1102 comprises a first clamping structure 11021, which has one side connected to a side edge of the fixing part 1101 and takes a U-shaped structure as a whole, a second clamping structure 11022 formed at a middle part of an outer side of the first clamping structure 11021 and protruding outwards, and a third clamping structure 11023 formed at an outer side of the first clamping structure 11021 and respectively located at two ends of the second clamping structure 11022.

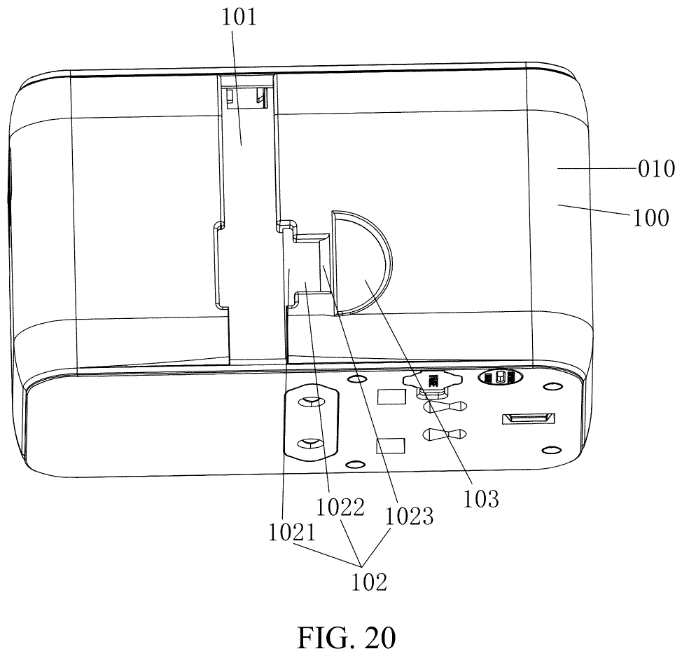

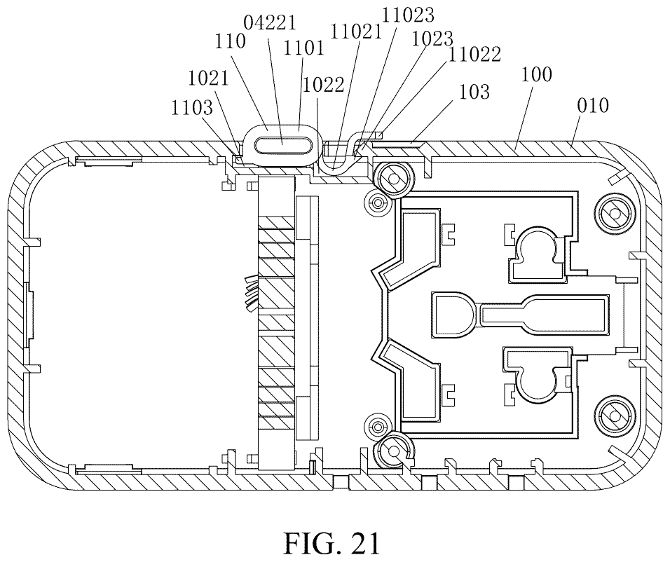

As for the specific means for the fixing and accommodating groove 102 to clamp and accommodate the fixing and accommodating part 110, as shown in FIGS. 20 and 21, the fixing and accommodating groove 102 comprises a fixing-part accommodating groove 1021 formed at a middle part of the line accommodating groove 101, and a fixing and accommodating groove 1022 formed at one side of the fixing-part accommodating groove 1021 and matching the clamping part 1102. The fixing part 1101 is accommodated at the middle part of the fixing-part accommodating groove 1021, the limiting part 1103 abuts against one side of the fixing-part accommodating groove 1021 away from the fixing and clamping groove 1022, so as to realize limiting and stabilizing of the fixing and accommodating part 110. The clamping part 1102 is clamped in the fixing and clamping groove 1022, and the fixing and accommodating part 110 is fixed on the fixing and accommodating groove 102, so that the fixing and accommodating part 110 drives the joint of the data line 0422 to be accommodated at a side edge of the housing 100, as a result of which the joint of the data line 0422 is prevented from being damaged by exterior collision or intertwining with other objects when it is displaced, space for placing the data line 0422 and the interface 04221 can be saved, and the power source converter can be more easily used when people go out.

As for the specific means of clamping and accommodating the clamping part 1102 into the fixing and clamping groove 1022, as shown in FIGS. 20 to 21, a clamping block 1023 inclining and extending from outside top towards inside bottom is formed at one side of the fixing and clamping groove 1022 away from the fixing-part accommodating groove 1021; and the third clamping structure 11023 is clamped under the clamping block 1023, and a first clamping structure 11021 protrudes into the fixing and clamping groove 1022, so that the clamping part 1102 is clamped into the fixing and clamping groove 1022, as a result of which the fixing and accommodating part 110 drives the interface 04221 of the data line 0422 to be clamped and accommodated at a side edge of the housing 100; and the second clamping structure 11022 covers and fits the clamping block 1023, so that the fixing and accommodating part 110 and the data line 0422 sleeved by the fixing and accommodating part 110 can be pulled out by people via the exposed second clamping structure 11022, as a result of which the present structure has a better use experience and can be more easily taken and used by people.

To make it easier for people to pull out and use the data line 0422 accommodated at the side edge of the housing 100 of the power source converter body 010, as shown in FIGS. 20 and 21, one side edge of the housing 100 close to the fixing and accommodating groove 102 is further provided with a handle groove 103, and an outermost end of the second clamping structure 11022 extends into the handle groove 103. The handle groove 103 gives way to the second clamping structure 11022, so that people can pull out the second clamping structure 11022, the outmost of which is in the handle groove 103, by stretching into the handle groove 103, as a result, the first clamping structure 11021 and the second clamping structure 11022 are driven by the second clamping structure 11022 and are pulled out of the fixing and clamping groove 1022, the fixing part 1101 is pulled out of the fixing part 1101 accommodating groove 1021, and the interface 04221 of the data line 0422 sleeved by the fixing part 1101 is thus pulled out of the fixing and accommodating groove 102, and the data line 0422 is thus pulled out of the line accommodating groove 101 for use. The entire process is convenient and efficient.

To make it easier for people to pull out the accommodated data line 0422 for use, as shown in FIG. 20, the handle groove 103 takes a shape of semicircle as a whole, with one end of its diameter edge facing the fixing and accommodating groove 102 and one end of its arc facing the exterior; since the arc structure is more aligned with people's habit of pulling things out and gives larger space, people can pull things out more easily, which makes the sense of using the present structure better.

The data line 0422 in Example 1 is prior art, so the interior structure and operation method or the like thereof are specifically explained in Example I. The joint in Example I may be a lightning/micro/type-c interface, which can be specifically provided according to necessities, and thus is not specifically limited in Example I.

### Example II

The specific structure of the present power source converter is explained in Example I. Example II mainly describes the differences from other examples, so identical structures will not be repeatedly explained here.

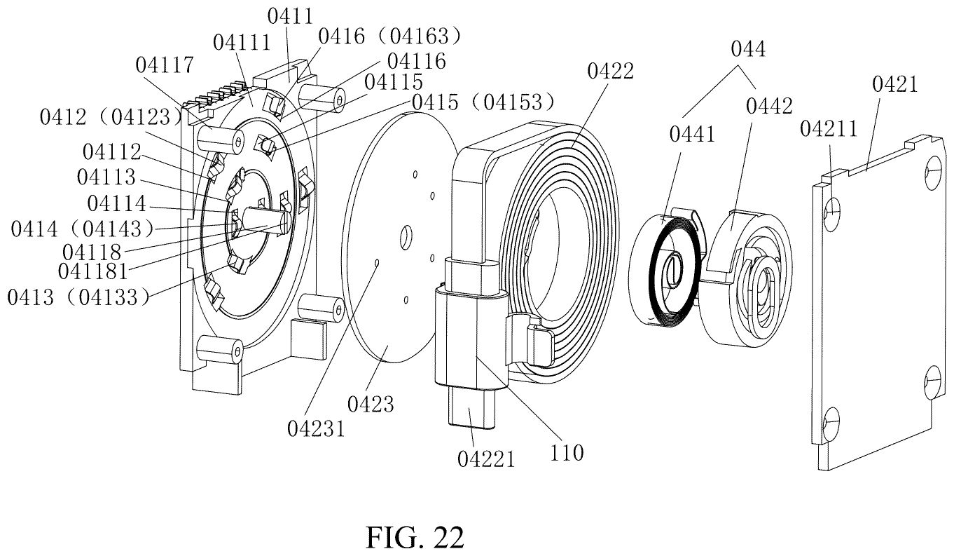

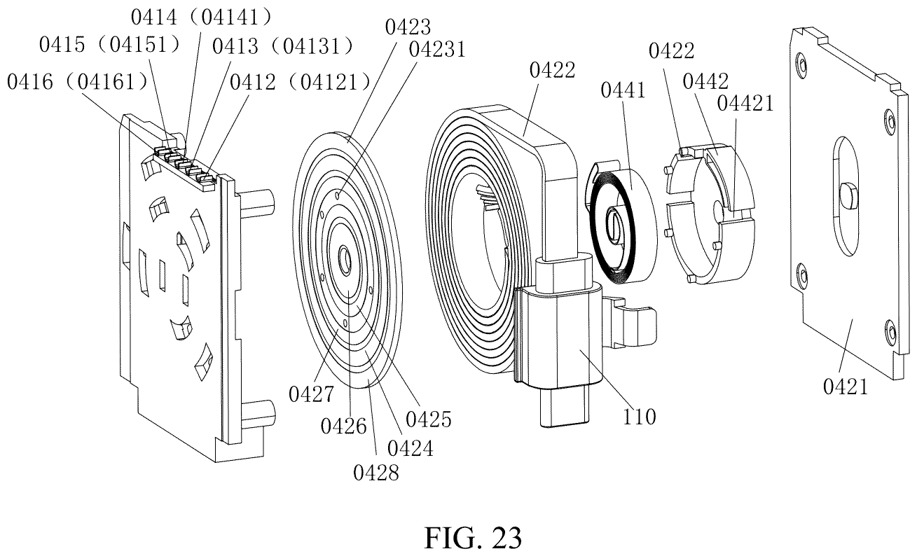

As shown in FIGS. 22 and 23, the main differences of Example II from Example I are as follows: in Example II, a second axis 04118 extending towards the second terminal assembly 042 is formed in a middle part of the first terminal fixing plate 0411, and the data line 0422 rotates around the second axis 04118 when pulled out.

As for the specific telescoping manner of the data line 0422, as shown in FIGS. 22 and 23, a second telescoping assembly 044, of which a middle part is clamped onto the second axis 04118 and the exterior is connected to the data line 0422, is further comprised, wherein the second telescoping assembly 044 comprises: a second spring 0441, a middle part of which is clamped into the second axis 04118, and a second line fixing part 0442 that is provided to sleeve an outer side of the second spring 0441 and is embedded in the data line 0422; the top end of the second axis 04118 is provided with a second spring mounting groove 041181, and an inner side of the second spring 0441 is embedded into the second spring mounting groove 041181. The second line fixing part 0442 is evenly provided with plural second mounting grooves 04421 at the outer side, and an innermost side of the data line 0422 is embedded into one set of second mounting grooves 04421, which realizes the connection between the data line 0422 and the second line fixing part 0442, and an outer side end of the second spring 0441 surrounds the outer side of the second line fixing part 0442 via another set of second mounting grooves 04421, thereby realizing connection between the second spring 0441 and the second line fixing part 0442. When the data line 0422 is pulled out by people, the data line 0422 drives the second line fixing part 0442 to rotate, and the second line fixing part 0442 drives the second spring 0441 to deform; when the data line 0422 is not needed, the second line fixing part 0442 and the data line 0422 rotate reversely under the elastic restoring force of the first spring 0431, thereby realizing the effect of retraction. The second telescoping assembly 044 may further comprise plural limiting bumps, balls and so on, so that the data line 0422 can be pulled out at equal intervals; such control means and structure are prior art and can be provided according to actual situation, and thus will not be repeated in this example.

As for the specific rotation manner of the wiring board 0423, as shown in FIGS. 22 and 23, one side of the second line fixing part 0442 facing the wiring board 0423 is provided with at least one second wiring board fixing column 04422, the wiring board 0423 is provided with at least one wiring board hole 04231 matching the wiring board fixing column 04422, and the second wiring board fixing column 04422 is mounted into the wiring board hole 04231, so that the wiring board 0423 is driven to rotate at the same time when the second line fixing part 0442 is driven to rotate by the data line 0422.

It should be noted here that the present disclosure discloses the power source converter having a data telescoping line and is an improvement of specific structure; and specific control methods are not innovative points of the present disclosure. The data line, interface, conductive solder pads, power source, protective tube and other parts mentioned in the present disclosure may be universally standard parts or parts known to a person skilled in the art, and the structures, principles and control methods thereof can all be known by a person skilled in the art through technical manual or conventional experimental methods.

Afore-mentioned are merely preferable examples of the present disclosure, rather than any limits on the technical scope of the present disclosure. Therefore, all other structures obtained by using technical features identical or similar to those in the examples of the present disclosure are within the scope of protection of the present disclosure.

1. A power source converter having a data telescoping line, comprising a power source converter body and a PCB provided in the power source converter body, and further comprising a European-standard pin assembly provided in the power source converter body and a data-line rotating and connecting device; wherein: the data-line rotating and connecting device comprises a first terminal assembly, and a second terminal assembly rotatably provided on the first terminal assembly; the first terminal assembly comprises a first terminal fixing plate, and plural conductive terminals embedded in the first terminal fixing plate; the second terminal assembly comprises: a second terminal fixing plate that covers and fits the first terminal fixing plate, a data line rotatably provided between the first terminal fixing plate and the second terminal fixing plate, and a wiring board that is in electric connection to the data line and is positioned between the data line and the first terminal fixing plate; the wiring board is provided with plural conductive solder pads that match, abut against and conduct with the conductive terminals; and at least one conducting part is provided on the conductive terminals, and the conducting part abuts against the conductive solder pads.

2. The power source converter having a data telescoping line according to claim 1, wherein: the data-line rotating and connecting device is provided between the PCB and the European-standard pin assembly, and is in electric connection to the PCB.

3. The power source converter having a data telescoping line according to claim 1, wherein: both the conductive terminals and the conductive solder pads are in 5 sets; the conductive terminals are respectively: a first conductive terminal embedded in the first terminal fixing plate, a second conductive terminal embedded in the first terminal fixing plate, a third conductive terminal embedded in the first terminal fixing plate, a fourth conductive terminal embedded in the first terminal fixing plate, and a fifth conductive terminal embedded in the first terminal fixing plate; and the conductive solder pads are respectively: a first conductive solder pad, a second conductive solder pad, a third conductive solder pad, a fourth conductive solder pad, and a fifth conductive solder pad.

4. The power source converter having a data telescoping line according to claim 3, wherein: the first conductive terminal comprises: a first circuit board connecting end extending to one side outside the first terminal fixing plate away from the wiring board, a first conducting piece connected to the first circuit board connecting end and matching the first conductive solder pad, and at least one first conducting part formed on the first conducting piece and bent to abut against the first conductive solder pad; the second conductive terminal comprises: a second circuit board connecting end extending to one side outside the first terminal fixing plate away from the wiring board, a second conducting piece connected to the second circuit board connecting end and matching the second conductive solder pad, and at least one second conducting part formed on the second conducting piece and bent to abut against the second conductive solder pad; the third conductive terminal comprises: a third circuit board connecting end extending to one side outside the first terminal fixing plate away from the wiring board, a third conducting piece connected to the third circuit board connecting end and matching the third conductive solder pad, and at least one third conducting part formed on the third conducting piece and bent to abut against the third conductive solder pad; the fourth conductive terminal comprises: a fourth circuit board connecting end extending to one side outside the first terminal fixing plate away from the wiring board, a fourth conducting piece connected to the fourth circuit board connecting end and matching the fourth conductive solder pad, and at least one fourth conducting part formed on the fourth conducting piece and bent to abut against the fourth conductive solder pad; the fifth conductive terminal comprises: a fifth circuit board connecting end extending to one side outside the first terminal fixing plate away from the wiring board, a fifth conducting piece connected to the fifth circuit board connecting end and matching the fifth conductive solder pad, and at least one fifth conducting part formed on the fifth conducting piece and bent to abut against the fifth conductive solder pad.

5. The power source converter having a data telescoping line according to claim 4, wherein: a middle part of the first terminal fixing plate is provided with a mounting slot for wiring and conduction, into which the wiring board can be embedded, wherein the mounting slot for wiring and conduction is provided with: at least one first conducting slot, through which the first conducting part stretches to abut against the first conductive solder pad, at least one second conducting slot, through which the second conducting part stretches to abut against the second conductive solder pad, at least one third conducting slot, through which the third conducting part stretches to abut against the third conductive solder pad, at least one fourth conducting slot, through which the fourth conducting part stretches to abut against the fourth conductive solder pad, and at least one fifth conducting slot, through which the fifth conducting part stretches to abut against the fifth conductive solder pad; and four corners of the first terminal fixing plate are respectively provided with an integral mounting column extending towards the second terminal fixing plate.

6. The power source converter having a data telescoping line according to claim 1, wherein: a live line conducting assembly, which is provided on the PCB and is in electric connection to the PCB, and a zero line conducting assembly, which is provided on the PCB and is in electric connection to the PCB, are comprised.

7. The power source converter having a data telescoping line according to claim 6, wherein: the live line conducting assembly comprises: a first live line conducting piece, a PCB live line gripper formed at one end of the first live line conducting piece and gripping the PCB, a second live line conducting piece, a first live line gripper formed at one end of the second live line conducting piece close to the first live line conducting piece and gripping the other end of the first live line conducting piece, and a European-standard live line gripper provided at one side of the second live line conducting piece close to the European-standard pin assembly.

8. The power source converter having a data telescoping line according to claim 7, wherein: the zero line conducting assembly comprises: a first zero line conducting piece, a PCB zero line gripper formed at one end of the first zero line conducting piece and gripping the PCB, a second zero line conducting piece, a first zero line gripper formed at one end of the second zero line conducting piece close to the first zero line conducting piece and gripping the other end of the first zero line conducting piece, and a European-standard zero line gripper provided at one side of the second zero line conducting piece close to the European-standard pin assembly.

9. The power source converter having a data telescoping line according to claim 8, wherein: the European-standard pin assembly comprises: a European-standard button provided in the power source converter body, a European-standard live line pin provided on the European-standard button, a European-standard live line conducting piece provided between the European-standard live line pin and the European-standard button and facing the European-standard live line gripper, a European-standard zero line pin provided on the European-standard button, and a European-standard zero line conducting piece provided between the European-standard zero line pin and the European-standard button and facing the European-standard zero line gripper.

10. The power source converter having a data telescoping line according to claim 1, wherein: the power source converter body further comprises a housing, and an outermost end of the data line is provided with an interface; the interface is sleeved with a fixing and accommodating part, and the housing is provided with a line accommodating groove matching the data line, and a fixing and accommodating groove formed in the line accommodating groove and matching the fixing and accommodating part.

11. The power source converter having a data telescoping line according to claim 10, wherein: the fixing and accommodating part comprises a fixing part sleeving the data line and having a hollow and flat shape as a whole, an all-in-one clamping part formed at one side of the fixing part, and an all-in-one limiting part formed at the other side of the fixing part; the clamping part comprises a first clamping structure, which has one side connected to a side edge of the fixing part and takes a U-shaped structure as a whole, a second clamping structure formed at a middle part of an outer side of the first clamping structure and protruding outwards, and a third clamping structure formed at an outer side of the first clamping structure and respectively located at two ends of the second clamping structure; the fixing and accommodating groove comprises a fixing-part accommodating groove formed at a middle part of the line accommodating groove, and a fixing and accommodating groove formed at one side of the fixing-part accommodating groove and matching the clamping part; a clamping block inclining and extending from outside top towards inside bottom is formed at one side of the fixing and clamping groove away from the fixing-part accommodating groove; and the third clamping structure is clamped under the clamping block, and the second clamping structure covers and fits the clamping block.
